(19) United States
(12) Patent Application Publication
(10) Pub. No.: US 2026/0175984 A1
(43) Pub. Date: Jun. 25, 2026

(54) PROPULSION ASSEMBLY FOR AIRCRAFT COMPRISING A TURBOJET ENGINE, A PYLON AND MEANS FOR MOUNTING THE TURBOJET ENGINE ON THE PYLON

(71) Applicant: Airbus Operations SAS, TOULOUSE (FR)

(72) Inventors: Jérôme CASSAGNE, TOULOUSE (FR); Alexandre BELLANGER, TOULOUSE (FR)

(21) Appl. No.: 19/426,686

(22) Filed: Dec. 19, 2025

(30) Foreign Application Priority Data
Dec. 23, 2024 (FR) FR2415149

(51) Int. Cl. B64D 27/40; B64D 27/18; F01D 25/28

(52) U.S. Cl. CPC B64D 27/402; B64D 27/18; F01D 25/28; F05D 2220/323; F05D 2240/14; F05D 2240/90

(57) ABSTRACT

A propulsion assembly of an aircraft comprising a turbojet engine with a front casing extending between a front face and a rear face, a mounting pylon having a primary structure with a front wall, and an engine mount having a first connecting rod and a second connecting rod, where one of the connecting rods is mounted in an articulated manner by a first connecting point on the front wall and by a second connecting point on the front casing, where the other of the connecting rods is mounted in an articulated manner by a third and a fourth connecting point on the front wall and by a fifth connecting point on the front casing, and where the connecting points are in the front third of the front casing.

### CROSS-REFERENCES TO RELATED APPLICATIONS

This application claims the benefit of French Patent Application Number FR 2415149 filed on Dec. 23, 2024, the entire disclosure of which is incorporated herein by way of reference.

### FIELD OF THE INVENTION

The present invention relates to the general field of mounting a turbojet engine below the wing of an aircraft. The invention relates, in particular, to a propulsion assembly comprising a turbojet engine, for example of the unducted turboprop type, a pylon and a mounting assembly designed to mount the turbojet engine below the pylon. The invention also relates to an aircraft provided with such a propulsion assembly.

### BACKGROUND OF THE INVENTION

An aircraft conventionally comprises wings and at least one propulsion assembly fixed below each of these wings. Each propulsion assembly comprises a mounting pylon and an engine. The mounting pylon has a rigid structure called the “primary structure” which is fixed between the wing and the engine by means of mounting assemblies, namely a first mounting assembly between the wing and the mounting pylon and a second mounting assembly between the pylon and the engine.

Although such an engine assembly is efficient, the development of turbojet engines results in the need to create different mounting pylons which, in particular, make it possible to relieve the turbojet engine of load.

### SUMMARY OF THE INVENTION

One subject of the present invention is to propose a propulsion assembly comprising a turbojet engine, a pylon and a mounting device designed for mounting the turbojet engine below the pylon.

To this end, a propulsion assembly of an aircraft is proposed, said propulsion assembly having a longitudinal axis and a vertical median plane passing through the longitudinal axis and comprising:
a turbojet engine comprising a front casing extending between a front face and a rear face perpendicular to the longitudinal axis,
a mounting pylon having a primary structure with a front wall,
an engine mount comprising a first connecting rod and a second connecting rod which are arranged on either side of the median plane, where one of the connecting rods is mounted in an articulated manner by a first connecting point on the front wall and by a second connecting point on the front casing, where the other of the connecting rods is mounted in an articulated manner by a third and a fourth connecting point on the front wall and by a fifth connecting point on the front casing, and where the connecting points are in the front third of the front casing, and
connecting rods mounted in an articulated manner between the mounting pylon and the turbojet engine.

In such an arrangement, the turbojet engine is relieved of load due to the axial moment being introduced as far as possible to the front.

Advantageously, the three connecting points providing the connection between a connecting rod and the front wall are aligned in a direction perpendicular to the median plane.

According to a particular embodiment, the propulsion assembly also comprises:
two external connecting rods arranged on either side of the median plane, where each external connecting rod has a rear end mounted in an articulated manner on a lower spar of the primary structure by a first rear connecting point and a front end mounted in an articulated manner on the rear face by a first front connecting point, and
two internal connecting rods arranged on either side of the median plane, where each internal connecting rod has a rear end mounted in an articulated manner on the lower spar by a second rear connecting point and a front end mounted in an articulated manner on the rear face by a second front connecting point.

Advantageously, each front and rear connecting point takes the form of a pivot connection, the axis thereof being perpendicular to the median plane.

According to one particular embodiment, the turbojet engine comprises a rear casing, where the longitudinal axis constitutes an axis of rotation of the turbojet engine and the propulsion assembly also comprises:
two external connecting rods arranged on either side of the median plane, where each external connecting rod has a rear end mounted in an articulated manner on the lower spar by a first rear connecting point and a front end mounted in an articulated manner on the rear face by a first front connecting point, and
two internal connecting rods arranged on either side of the median plane, where each internal connecting rod has a rear end mounted in an articulated manner on the lower spar by a second rear connecting point and a front end mounted in an articulated manner on the rear face or on the rear casing by a second front connecting point and where the axes of the internal connecting rods converge toward the longitudinal axis.

Advantageously, the propulsion assembly also comprises a propeller at the front of the front casing and the convergence to the longitudinal axis takes place in the region of the center of the propeller.

Advantageously, the front connecting points of the external connecting rods are aligned along a horizontal straight transverse line.

Advantageously, each front and rear connecting point of the external connecting rods takes the form of a pivot connection, the axis thereof being perpendicular to the median plane.

The invention also proposes an aircraft comprising a wing and a propulsion assembly according to one of the preceding variants, the primary structure thereof being fixed below the wing.

### BRIEF DESCRIPTION OF THE DRAWINGS

The above-mentioned features of the invention, and others, will become more apparent by reading the following description of an exemplary embodiment, said description being made relative to the accompanying drawings, in which:

FIG. 1 shows a side view of an aircraft according to the invention,

FIG. 2 is a schematic view of a propulsion assembly according to a first embodiment of the invention in side view,

FIG. 3 is a perspective view of a propulsion assembly according to the first embodiment of the invention,

FIG. 4 is a schematic view of a propulsion assembly according to a second embodiment of the invention in side view,

FIG. 5 is a perspective view of a propulsion assembly according to the second embodiment of the invention, and

FIG. 6 is a front view of an engine mount implemented in the invention.

### DETAILED DESCRIPTION OF THE PREFERRED EMBODIMENTS

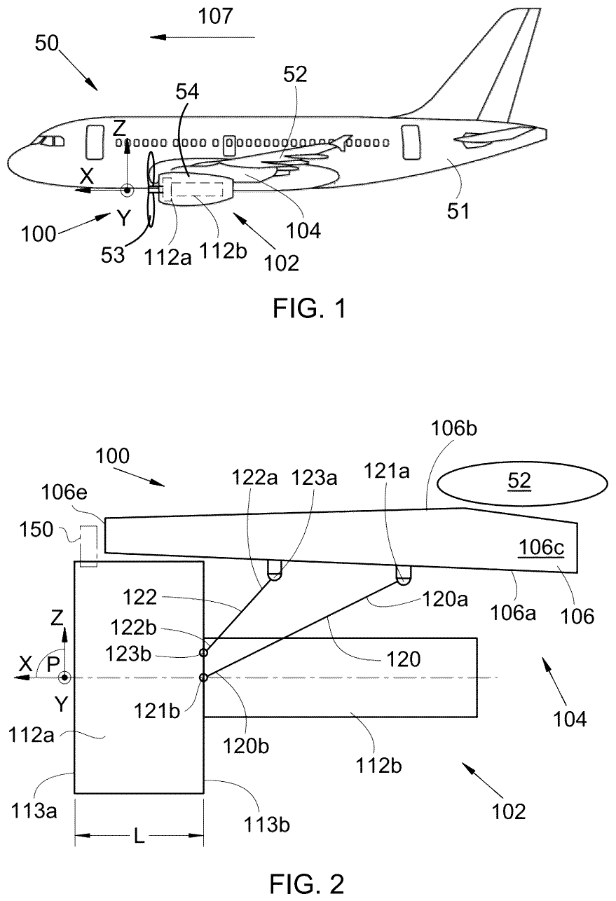

With reference to FIG. 1, an aircraft 50 comprises a fuselage 51 to which a wing 52 is fixed on each side, at least one propulsion assembly 100 according to the invention being mounted therebelow.

The propulsion assembly 100, 200 comprises a mounting pylon 104 fixed below the wing 52 and a turbojet engine 102 fixed below the mounting pylon 104. The turbojet engine 102 is of the unducted propfan type.

Conventionally X is the longitudinal axis of the turbojet engine 102 and thus of the propulsion assembly 100, 200, this longitudinal axis X being parallel to a longitudinal direction of this turbojet engine 102. On the other hand, Y is the transverse axis of the turbojet engine 102 which is horizontal when the aircraft is on the ground and Z is the vertical axis or vertical height when the aircraft is on the ground, these three directions X, Y and Z being at right-angles to one another.

On the other hand, the terms “front” and “rear” are to be considered relative to a forward direction of travel of the aircraft 50 during the operation of the turbojet engine 102, this direction being represented schematically by the arrow 107 in FIG. 1.

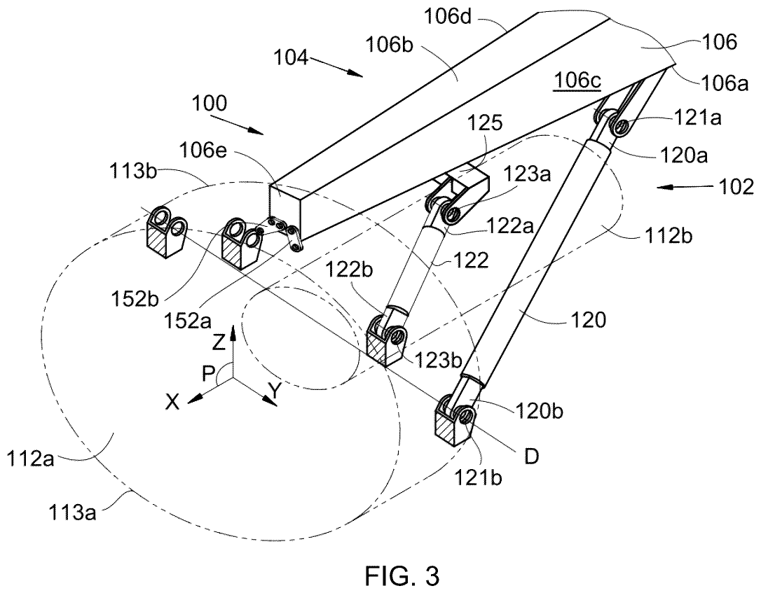

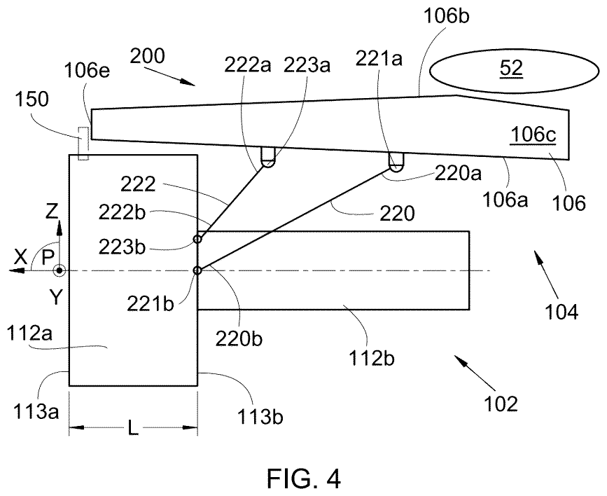

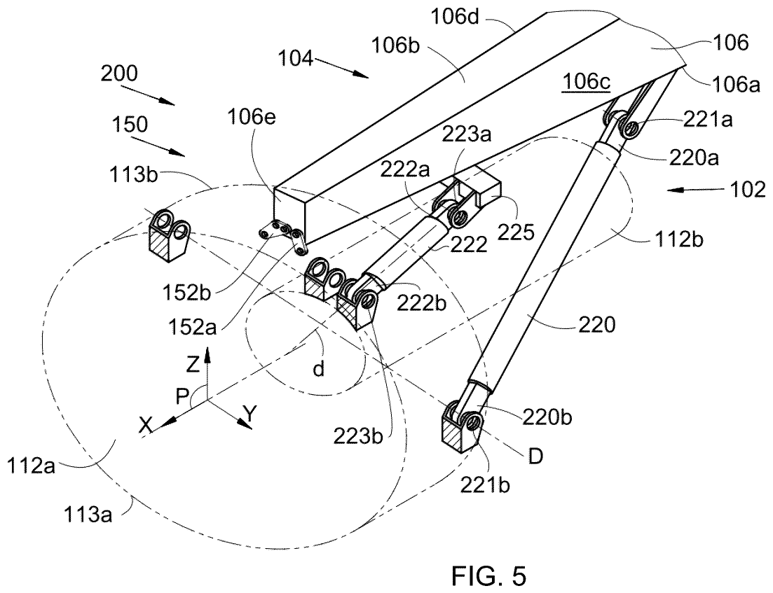

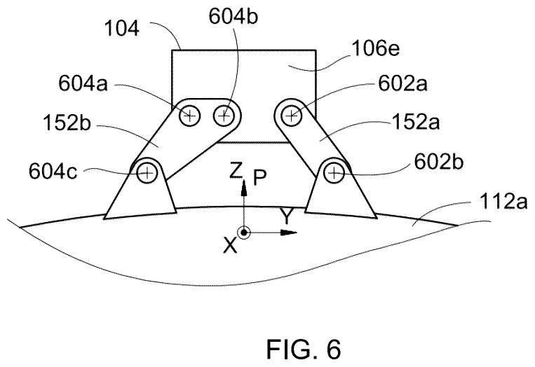

FIG. 2 and FIG. 3 show the propulsion assembly 100 according to a first embodiment of the invention and FIG. 4 and FIG. 5 show the propulsion assembly 200 according to a second embodiment of the invention. FIG. 6 shows a detail of an engine mount 150 which provides a fixing between the mounting pylon 104 and the turbojet engine 102.

The turbojet engine 102 comprises, from front to rear, a propeller 53, a nacelle 54 in which the other elements of the turbojet engine 102 are housed and which take the form of a core having a front casing 112a and a rear casing 112b which is fixed to the rear of the front casing 112a and in which the other elements of the turbojet engine 102 are housed, such as compression stages, a combustion chamber, turbine stages and an exhaust cone. The rear casing 112b and the front casing 112a are coaxial with the longitudinal axis X and the rear casing 112b has a smaller diameter than that of the front casing 112a. The rear casing 112b extends in this case from a rear face 113b of the front casing 112a which is perpendicular to the longitudinal axis X which constitutes an axis of rotation of the turbojet engine 102. The mounting pylon 104 is represented here by its primary structure 106, and is fixed to the structure of the wing 52 by any appropriate securing means known to the person skilled in the art. The front casing 112a extends between a front face 113a and the rear face 113b which are perpendicular to the longitudinal axis X.

The primary structure 106 is in the form of a box structure extending in the longitudinal direction X, and comprises a front wall 106e located at the front of the primary structure 106, a lower spar 106a extending below the primary structure 106 and an upper spar 106b extending above the primary structure 106. The primary structure 106 also comprises two lateral walls 106c-d on each side of the vertical median plane P. These different spars and walls are fixed to one another to form the primary structure 106.

The mounting pylon 104 and the turbojet engine 102 are generally symmetrical relative to a vertical median plane XZ of the propulsion assembly 100 which passes through the longitudinal axis X, which is called hereinafter the median plane P and which separates the mounting pylon 104 and the turbojet engine 102 into two port-starboard parts.

In each of the two embodiments of the invention shown here, the propulsion assembly 100, 200 comprises an engine mount 150 which provides a fixing between the front wall 106e of the primary structure 106 and the front casing 112a.

The engine mount 150 comprises a first connecting rod 152a and a second connecting rod 152b which are arranged on either side of the median plane P, with in this case the first connecting rod 152 on the port side and the second connecting rod 152b on the starboard side but the reverse arrangement is also possible.

One of the two connecting rods 152a is mounted (in this case on the port side) in an articulated manner by a first connecting point 602a on the front wall 106e and by a second connecting point 602b on the front casing 112a.

The other of the two connecting rods 152b is mounted (in this case on the starboard side) in an articulated manner by a third 604a and a fourth 604b connecting point on the front wall 106e and by a fifth connecting point 604c on the front casing 112a.

The connecting points 602a-b and 604a-c relative to the first connecting rod 152a and the second connecting rod 152b are in the front third of the front casing 112a. In other words, taking into account that the front casing 112a has a length L parallel to the longitudinal axis X between the front face 113a and the rear face 113b, the connecting points 602a-b and 604a-c are at a maximum of a distance L/3 from the front face 113a.

In such an arrangement, the axial moment Mx and the forces transmitted vertically parallel to the vertical axis Z and transversely parallel to the transverse axis Y are transmitted to the mounting pylon 104 without passing through the entire front casing 112a.

In the embodiment of the invention shown in FIG. 6, the three connecting points 602a and 604a-b providing the connection between a connecting rod 152a-b and the front wall 106e are aligned in a direction perpendicular to the median plane P in order to block the rotation about the longitudinal axis X.

Each connecting point 602a-b, 604a-c provides at least one pivot connection about an axis parallel to the longitudinal axis X, but according to a preferred embodiment each connecting point 602a-b, 604a-c provides a ball joint.

The two particular arrangements which are described hereinafter use two external connecting rods 120, 220 and two internal connecting rods 122, 222 which make it possible to obtain a statically undetermined system of the first degree which ensures safety, for example, in the case of a rupture of a connecting rod 120, 122, 220, 222. Each connecting rod 120, 122, 220, 222 also provides a take-up of forces along its axis. The connecting rods 120, 122, 220 and 222 are mounted in an articulated manner between the mounting pylon 104 and the turbojet engine 102.

In the first embodiment of the invention shown in FIGS. 2 and 3, the propulsion assembly 100 thus comprises two external connecting rods 120 which are arranged on either side of the median plane P. Each external connecting rod 120 has a rear end 120a which is mounted in an articulated manner on the lower spar 106a by a first rear connecting point 121a and a front end 120b which is mounted in an articulated manner on the rear face 113b of the front casing 112a by a first front connecting point 121b.

In the same manner, in the first embodiment of the invention, the propulsion assembly 100 comprises the two internal connecting rods 122 which are arranged on either side of the median plane P. Each internal connecting rod 122 has a rear end 122a which is mounted in an articulated manner on the lower spar 106a by a second rear connecting point 123a and a front end 122b which is mounted in an articulated manner on the rear face 113b by a second front connecting point 123b.

The internal connecting rods 122 are located inside the propulsion assembly 100 relative to the external connecting rods 120 which are on the outside of the internal connecting rods 122 and which extend further to the rear relative to the internal connecting rods 122.

The second rear connecting point 123a is arranged at the front relative to the first rear connecting point 121a.

In such an arrangement, the connecting rods 120 and 122 are spaced apart from the rear casing 112b, permitting easier access to the inside of the propulsion assembly 100.

In the embodiment of the invention shown here, the two front connecting points 121b of the external connecting rods 120 are aligned along a straight transverse line D which is horizontal and thus in this case parallel to the transverse axis Y.

The straight transverse line D is also in this case perpendicular to the median plane P and thus parallel to the transverse axis Y.

In the embodiment of the invention shown here, each connecting point 121a-b, 123a-b takes the form of a pivot connection, the axis thereof being perpendicular to the median plane P but a different orientation is possible.

To this end, each connecting point 121a-b, 123a-b takes the form of a clevis type connection, with a male clevis mounted movably in rotation in a female clevis by means of a pin.

For each front connecting point 121b, 123b, the female clevis is secured to the rear face 113b and the male clevis consists of the front end 120b, 122b of the relevant connecting rod 120, 122.

For each rear connecting point 121a, 123a the female clevis is secured to the lower spar 106a and the male clevis consists of the rear end 120a, 122a of the relevant connecting rod 120, 122. In this case, the female clevises of the rear connecting points 123a of the internal connecting rods 122 are fixed to a beam 125 which is secured to the lower spar 106a and which extends in this case laterally beyond the primary structure 106.

In the second embodiment of the invention shown in FIGS. 4 and 5, the propulsion assembly 200 thus comprises two external connecting rods 220 which are arranged on either side of the median plane P. Each external connecting rod 220 has a rear end 220a which is mounted in an articulated manner on the lower spar 106a by a first rear connecting point 221a and a front end 220b which is mounted in an articulated manner on the rear face 113b of the front casing 112a by a first front connecting point 221b.

In the same manner, in the second embodiment of the invention the propulsion assembly 200 also comprises two internal connecting rods 222 which are arranged on either side of the median plane P. Each internal connecting rod 222 has a rear end 222a which is mounted in an articulated manner on the lower spar 106a by a second rear connecting point 223a and a front end 222b which is mounted in an articulated manner on the rear face 113b or on the rear casing 112b by a second front connecting point 223b.

The internal connecting rods 222 are located on the inside of the propulsion assembly 100 relative to the external connecting rods 220 which are on the outside of the internal connecting rods 222 and which extend further to the rear relative to the internal connecting rods 222.

The second rear connecting point 223a is arranged at the front relative to the first rear connecting point 221a.

Moreover, the axes of the internal connecting rods 222 converge toward the longitudinal axis X. The axis of a connecting rod being the axis connecting together the two ends of the connecting rod and shown here by the reference “d” in FIG. 3. According to a preferred embodiment, the convergence on the longitudinal axis X takes place in the region of the center of the propeller 53 which is at the front of the front casing 112a, i.e., the intersection between the longitudinal axis X and the plane of the propeller 53.

In such an arrangement, the internal connecting rods 222 converge toward the axis of rotation X of the turbojet engine 102 to minimize the forces.

In the embodiment of the invention shown here, the two front connecting points 221b of the external connecting rods 220 are aligned along a straight transverse line D which is horizontal and thus in this case parallel to the transverse axis Y.

The straight transverse line D is also in this case perpendicular to the median plane P and thus parallel to the transverse axis Y.

In the embodiment of the invention shown here, each connecting point 221a-b, 223a-b takes the form of a pivot connection and for the external connecting rods 220 the axis of the pivot connection is perpendicular to the median plane P but a different orientation is possible.

To this end, each connecting point 221a-b, 223a-b takes the form of a clevis type connection with a male clevis mounted movably in rotation in a female clevis by means of a pin.

For each front connecting point 221b of an external connecting rod 220, the female clevis is secured to the rear face 113b and the male clevis consists of the front end 220b of the relevant connecting rod 220. For each front connecting point 223b of an internal connecting rod 222, the female clevis is secured to the rear face 113b or to the rear casing 112b and the male clevis consists of the front end 222b of the relevant connecting rod 222.

For each rear connecting point 221a, 223a, the female clevis is secured to the lower spar 106a and the male clevis consists of the rear end 220a, 222a of the relevant connecting rod 220, 222. Here the female clevises of the rear connecting points 223a of the internal connecting rods 222 are fixed to a beam 225 secured to the lower spar 106a, and which in this case extends laterally beyond the primary structure 106.

While at least one exemplary embodiment of the present invention(s) is disclosed herein, it should be understood that modifications, substitutions and alternatives may be apparent to one of ordinary skill in the art and can be made without departing from the scope of this disclosure. This disclosure is intended to cover any adaptations or variations of the exemplary embodiment(s). In addition, in this disclosure, the terms “comprise” or “comprising” do not exclude other elements or steps, the terms “a” or “one” do not exclude a plural number, and the term “or” means either or both. Furthermore, characteristics or steps which have been described may also be used in combination with other characteristics or steps and in any order unless the disclosure or context suggests otherwise. This disclosure hereby incorporates by reference the complete disclosure of any patent or application from which it claims benefit or priority.

1. A propulsion assembly of an aircraft, said propulsion assembly having a longitudinal axis and a vertical median plane passing through the longitudinal axis and comprising:
a turbojet engine comprising a front casing extending between a front face and a rear face perpendicular to the longitudinal axis;
a mounting pylon having a primary structure with a front wall;
an engine mount comprising a first connecting rod and a second connecting rod which are arranged, respectively, on each side of the median plane, wherein one of the first and second connecting rods is mounted in an articulated manner by a first connecting point on the front wall and by a second connecting point on the front casing, wherein the other of the first and second connecting rods is mounted in an articulated manner by a third connecting point and a fourth connecting point on the front wall and by a fifth connecting point on the front casing, and wherein the first connecting point, the second connecting point, the third connecting point, the fourth connecting point, and the fifth connecting point are in a front third of the front casing;
connecting rods mounted in an articulated manner between the mounting pylon and the turbojet engine;
two external connecting rods arranged, respectively, on each side of the median plane, wherein each external connecting rod has a rear end mounted in an articulated manner on a lower spar of the primary structure by a first rear connecting point and a front end mounted in an articulated manner on the rear face by a first front connecting point;
two internal connecting rods arranged, respectively, on each side of the median plane, wherein each internal connecting rod has a rear end mounted in an articulated manner on the lower spar by a second rear connecting point and a front end mounted in an articulated manner on the rear face by a second front connecting point.

2. The propulsion assembly according to claim 1, wherein all connecting points providing a connection between a connecting rod and the front wall are aligned in a direction perpendicular to the median plane.

3. The propulsion assembly according to claim 2, wherein each front connecting point and rear connecting point comprises a pivot connection with an axis perpendicular to the median plane.

4. A propulsion assembly of an aircraft, said propulsion assembly having a longitudinal axis and a vertical median plane passing through the longitudinal axis, and the propulsion assembly comprising:
a turbojet engine comprising a front casing extending between a front face and a rear face perpendicular to the longitudinal axis and a rear casing, wherein the longitudinal axis comprises an axis of rotation of the turbojet engine;
a mounting pylon having a primary structure with a front wall;
an engine mount comprising a first connecting rod and a second connecting rod which are arranged, respectively, on each side of the median plane, wherein one of the first and second connecting rods is mounted in an articulated manner by a first connecting point on the front wall and by a second connecting point on the front casing, wherein the other of the first and second connecting rods is mounted in an articulated manner by a third connecting point and a fourth connecting point on the front wall and by a fifth connecting point on the front casing, and wherein the first connecting point, the second connecting point, the third connecting point, the fourth connecting point, and the fifth connecting point are in a front third of the front casing;
connecting rods mounted in an articulated manner between the mounting pylon and the turbojet engine;
two external connecting rods arranged, respectively, on both sides of the median plane, wherein each external connecting rod has a rear end mounted in an articulated manner on a lower spar of the primary structure by a first rear connecting point and a front end mounted in an articulated manner on the rear face by a first front connecting point; and
two internal connecting rods arranged, respectively, on both sides of the median plane, wherein each internal connecting rod has a rear end mounted in an articulated manner on the lower spar by a second rear connecting point and a front end mounted in an articulated manner on the rear face or on the rear casing by a second front connecting point, and wherein axes of the two internal connecting rods converge toward the longitudinal axis.

5. The propulsion assembly according to claim 4, wherein all connecting points providing a connection between a connecting rod and the front wall are aligned in a direction perpendicular to the median plane.

6. The propulsion assembly according to claim 5, wherein each front connecting point and rear connecting point comprises a pivot connection with an axis perpendicular to the median plane.

7. The propulsion assembly according to claim 4, further comprising:
a propeller at a front of the front casing,
wherein the two internal connecting rods converge toward the longitudinal axis in a region of a center of the propeller.

8. The propulsion assembly according to claim 7, wherein the first front connecting points of the external connecting rods are aligned along a horizontal straight transverse line.

9. The propulsion assembly according to claim 8, wherein each front connecting point and rear connecting point of the two external connecting rods comprises a pivot connection having an axis perpendicular to the median plane.

10. The propulsion assembly according to claim 7, wherein each front connecting point and rear connecting point of the two external connecting rods comprises a pivot connection having an axis perpendicular to the median plane.

11. The propulsion assembly according to claim 4, wherein each front connecting point and rear connecting point of the two external connecting rods comprises a pivot connection having an axis perpendicular to the median plane.

12. The propulsion assembly according to claim 4, wherein the first front connecting points of the external connecting rods are aligned along a horizontal straight transverse line.

13. An aircraft comprising:
a wing; and
the propulsion assembly according to claim 4, the primary structure thereof being fixed below the wing.

14. An aircraft comprising:
a wing; and
the propulsion assembly according to claim 1, the primary structure thereof being fixed below the wing.
